(19) United States
(12) Patent Application Publication
(10) Pub. No.: US 2007/0190333 A1
(43) Pub. Date: Aug. 16, 2007

(54) Polyolefin-based molded product coated with polar polymer, method for producing the same, and uses of the same

(75) Inventors: Tomoaki Matsugi, Sodegaura-shi (JP); Shin-ichi Kojoh, Tokyo (JP); Nobuo Kawahara, Sodegaura-shi (JP); Shingo Matsuo, Sodegaura-shi (JP); Hideyuki Kaneko, Sodegaura-shi (JP); Takayuki Onogi, Sodegaura-shi (JP); Junji Saito, Sodegaura-shi (JP); Norio Kashiwa, Sodegaura-shi (JP)

Correspondence Address: BIRCH STEWART KOLASCH & BIRCH, PO BOX 747, FALLS CHURCH, VA, 22040-0747, US

(73) Assignee: MITSUI CHEMICALS, INC., Tokyo (JP)

(21) Appl. No.: 11/491,894

(22) Filed: Jul. 25, 2006

Related U.S. Application Data
(60) Provisional application No. 60/804,874, filed on Jun. 15, 2006.
(60) Provisional application No. 60/815,586, filed on Jun. 22, 2006.

(30) Foreign Application Priority Data
Feb. 13, 2006 (JP) 2006-035094

(51) Int. Cl. B32B 27/36; B32B 27/32; B32B 15/08; B32B 17/10

(52) U.S. Cl. 428/420; 428/523; 428/461; 428/483; 428/441; 525/244

(57) ABSTRACT

A polyolefin-based molded product having excellent printability, coatability, heat resistance, impact resistance, hydrophilicity or hydrophobicity, or exhibiting excellent performance such as the performance of adhesion with metal, plastics, paper and the like, that is, a polyolefin-based molded product which is coated with a polar segment layer through covalent bonding, without impairing the properties of the polyolefin base material and without substantial delamination at the interface, based on a novel conception that a polyolefin molded product has a structure of being coated with polar polymer segments at the surface, and a vinylic monomer or a small-membered cyclic compound is polymerized on the surface; and a method for producing the same are provided. A polyolefin-based molded product having a polar polymer (B) coated on the surface of a polyolefin molded product (A), characterized by having a structure in which the polar polymer (B) is bound to the surface of the polyolefin molded product (A) through covalent bonding, and a method for producing the same are provided.

### TECHNICAL FIELD

The present invention relates to a polyolefin-based molded product coated with a polar polymer, a method for producing the same, and uses of the same.

### BACKGROUND ART

Polyolefins such as polyethylene, polypropylene and the like are characterized by having excellent properties and processability, in addition to being lightweight and inexpensive. On the other hand, from the viewpoint of imparting high functionality such as printability, coatability, adhesiveness, heat resistance, impact resistance, hydrophilicity, stimulation responsiveness, and adhesiveness, compatibility and the like with other polar polymers or metals, high chemical stability thereof is troublesome. As a method for complementing such defects and imparting functionality to the polyolefins, for example, a method of copolymerizing ethylene with a polar group-containing monomer such as vinyl acetate, methacrylic acid or the like according to the high pressure radical polymerization technique; a method of grafting a polar group-containing monomer such as maleic anhydride or the like to a polyolefin in the presence of an oxide; and the like are widely used in general. Furthermore, JP-A-06-172459, JP-A-07-149911, JP-A-2000-159843, JP-A-2004-162054 and so forth disclose methods for modifying a polyolefin by melt kneading a polymerizable monomer having a polar group, or a polymer thereof, together with a polyolefin resin in the presence of a radical precursor, which is represented by peroxides. On the other hand, in JP-A-2004-131620 filed by the present Applicant, a method is disclosed for grafting a polar group-containing monomer such as acrylate or the like through radical polymerization, by converting the polar group into a radical polymerization initiator in the polyolefin obtained by copolymerizing an olefin and the polar group-containing monomer. According to this method, a polyolefin-polymer hybrid polymer in which the presence of non-grafted polymers such as plain polyolefin and the polymer unit made from a polar group-containing monomer has been minimized due to suppressed side reactions such as crosslinking or decomposition, can be obtained. However, the molded products to be obtained from the polyolefin-based materials obtained by these methods have polar groups or polar polymer segments present both in the interior and at the surface of the polyolefin. Thus, it is difficult to exhibit an effect of sufficiently modifying the properties of the surface of polyolefin molded products, and further, the presence of heterogeneous polymers being dispersed in the interior of the polyolefin, may cause impairment of the properties inherent to the polyolefin.

On the other hand, production of a laminate film, of which the characteristics that are impossible to be obtained with polyolefin alone, for example, strength, gas barrier properties, moisture resistance, heat sealability, appearance and the like, are complemented by a technique of adhering a film of a heterogeneous material on the surface of a polyolefin molded product, is generally implemented, and the products thus obtained are widely used, mainly for packaging materials and the like. The methods of producing such laminate film include a dry lamination method, a wet lamination method, a hot lamination method, an extrusion lamination method, and a co-extrusion lamination method, and these methods are being applied in accordance with the respective features. These lamination techniques required the surface treatment of the polyolefin molded product such as oxidation, ozonization, and applying adhesives such as organic titanates, organic isocyanates, polyethyleneimines in order to adhere a polyolefin molded product having poor adhesiveness essentially to a film of heterogeneous material. Complicatedness of such processes, limitation in the applicable materials due to the use of adhesives, or delamination due to poor interfacial adhesion or deterioration has been addressed as the problems.

[Patent Document 1] JP-A-06-172459

[Patent Document 2] JP-A-07-149911

[Patent Document 3] JP-A-2000-159843

[Patent Document 4] JP-A-2004-162054

[Patent Document 5] JP-A-2004-131620

### DISCLOSURE OF THE INVENTION

The problem that the inventors of the present invention are attempting to solve for such circumstances, is to provide a polyolefin-based molded product which is coated with a polar segment layer through covalent bonding, without having the properties of the polyolefin base material impaired and without substantial delamination at the interface, on the basis of a novel conception that the polyolefin molded product has a structure in which the polar polymer is coated only on the surface, and a vinylic monomer or a small-membered cyclic compound is polymerized at the surface.

The polyolefin-based molded product coated with a polar polymer (B) according to the present invention is a polyolefin-based molded product comprising a polyolefin molded product (A) coated with a polar polymer (B) on a surface thereof, characterized by having a structure in which the polar polymer (B) is bound to the surface of the polyolefin molded product (A) through covalent bonding.

The polyolefin-based molded product of the invention has a structure in which polar polymer segments are coated on the surface of a polyolefin molded product through covalent bonding, and thus the properties of the polyolefin base material are not impsired and delamination at the interface between the surface of the polyolefin molded product and the polar polymer segments dose not occur substantially.

### BEST MODE COR CARRYING OUT THE INVENTION

Hereinafter, the polyolefin-based molded product coated with a polar polymer according to the present invention, and a method for producing the same will be described in detail. Further, according to the invention, the term “coating” is defined to imply that a layer of the polar polymer is coated on the surface of the polyolefin-based molded product through covalent bonding, and thus, physical adhesion or coating based on ionic bonding is not encompassed by the definition of the “coating” according to the invention.

The polyolefin-based molded product coated with the polar polymer (B) according to the invention is a polyolefin-based molded product comprising a polyolefin molded product (A) coated with a polar polymer (B) on the surface, characterized by having a structure in which the polar polymer (B) is bound to the surface of the polyolefin molded product (A) through covalent bonding.

Polyolefin Molded Product (A)

The polyolefin molded product (A) constituting the polyolefin-based molded product of the invention is a molded product of at least one resin selected from the group consisting of the following (I) to (III).

(I) Homopolymer or copolymer resins of the monomers selected from the group consisting of the following (A1) to (A3).

(A1) Homopolymers or copolymers of an α-olefin compound represented by CH₂═CH—CₓH₂ₓ₊₁ (wherein x is 0 or a positive integer).

(A2) Copolymers of an α-olefin compound represented by CH₂═CH—CₓH₂ₓ₊₁ (wherein x is 0 or a positive integer) and a mono-olefin compound having an aromatic ring.

(A3) Copolymers of an α-olefin compound represented by CH₂═CH—CₓH₂ₓ₊₁ (wherein x is 0 or a positive integer) and a cyclic mono-olefin compound represented by the following Formula (1):

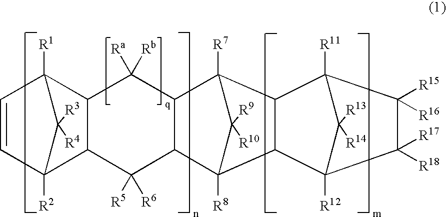

For the Formula (1), n is 0 or 1, m is 0 or a positive integer, and q is 0 or 1. When q is 1, R^{a} and R^{b} each independently represent the following atom or hydrocarbon group, while when q is 0, the respective bonds are joined to form a 5-membered ring.

For the Formula (1), R¹ to R¹⁸, and R^{a} and R^{b} each independently represent an atom or a group selected from the group consisting of a hydrogen atom, a halogen atom, and a hydrocarbon group.

Here, the halogen atom is a fluorine atom, a chlorine atom, a bromine atom or an iodine atom. The hydrocarbon group may be each independently and usually exemplified by an alkyl group having 1 to 20 carbon atoms, a halogenated alkyl group having 1 to 20 carbon atoms or a cycloalkyl group having 3 to 15 carbon atoms. More specifically, the alkyl groups may include a methyl group, an ethyl group, a propyl group, an amyl group, a hexyl group, an octyl group, a decyl group, a dodecyl group and an octadecyl group. The halogenated alkyl groups may include a group in which at least a portion of the hydrogen atoms constituting the alkyl group as described above is substituted with a fluorine atom, a chlorine atom, a bromine atom or an iodine atom. The cycloalkyl groups may include a cyclohexyl group.

Such group may contain a lower alkyl group. Furthermore, for the Formula (1), R¹⁵ and R¹⁶, R¹⁷ and R¹⁸, R¹⁵ and R¹⁷, R¹⁶ and R¹⁸, R¹⁵ and R¹⁸, or R¹⁶ and R¹⁷ may be respectively bonded (be combined with each other) to form a monocyclic or polycyclic ring. The monocyclic or polycyclic ring formed herein may be specifically exemplified as follows:

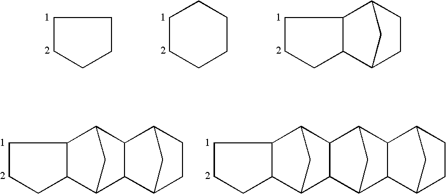

For the above examples, the carbon atoms numbered 1 and 2 represent the carbon atoms to which R¹⁵ (R¹⁶) and R¹⁷ (R¹⁸) are bound respectively in the Formula (1).

The cyclic olefins represented by the Formula (1) may include bicyclo[2.2.1]hept-2-ene derivatives,
tricyclo[4.3.0.1^{2,5}]-3-decene derivatives,
tricyclo[4.3.0.1^{2,5}]-3-undecene derivatives,
tetracyclo[4.4.0.1^{2,5}.1^{7,10}]-3-dodecene derivatives,
pentacyclo[7.4.0.1^{2,5}.1^{9,12}.0^{8,13}]-3-pentadecene derivatives,
pentacyclo[6.5.1.1^{3,6}.0^{2,7}.0^{9,13}] -4-pentadecene derivatives,
pentacyclo[8.4.0.1^{2,3}.1^{9,12}.0^{8,13}]-3-hexadecene derivatives,
pentacyclo[6.6.1.1^{3,6}.0^{2,7}.0^{9,14}]-4-hexadecene derivatives,
pentacyclopentadecadiene derivatives,
hexacyclo[6.6.1.1^{3,6}.1^{10,13}.0^{2,7}.0^{9,14}] -4-heptadecene derivatives, heptacyclo[8.7.0.1^{3,6}.1^{10,17}. 1^{12,15}.0^{2,7}.0^{11,16}] -4-eicosene derivatives, heptacyclo-5-eicosene derivatives,
heptacyclo[8.8.0.1^{4,7}.1^{11,18}.1^{13,16}.0^{3,8}.0^{12,17}] -5-heneicosene derivatives, octacyclo[8.8.0.1^{2,9}.1^{4,7}.1^{11,18}.1^{13,16}.0^{3,8}.0^{12,17}]-5-docosene derivatives,
nonacyclo [10.9.1.1^{4,7}.1^{13,20}.1^{15,18}.0^{3,8}.0^{2,10}.0^{12,21}.0^{14,19}]-5-pentacosene derivatives, and
nonacyclo[10.10.1.1^{5,8}.1^{14,21}.1^{16,19}.0^{2,11}.0^{4,9}.0^{13,22}.0^{15,20}]-5-hexacosene derivatives.

Such cyclic mono-olefin compound represented by Formula (1) can be produced by subjecting an olefin having a corresponding structure and cyclopentadiene to the Diels-Alder reaction. These cyclic olefins can be used singly or in combination of two or more species.

(A1) Homopolymer or Copolymer of an α-Olefin Compound Represented by CH₂═CH—CₓH₂ₓ₊₁ (Wherein x is 0 or a Positive Integer)

For the homopolymer or copolymer of an α-olefin compound represented by CH₂═CH—CₓH₂ₓ₊₁ (wherein x is 0 or a positive integer) used in the invention, the α-olefin compounds represented by CH₂═CH—CₓH₂ₓ₊₁ (wherein x is 0 or a positive integer) may include a straight-chained and branched α-olefin having 4 to 20 carbon atoms, such as ethylene, propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, and 1-eicosene. Among these exemplary olefins, it is preferable to use at least one or more olefins selected from ethylene, propylene, 1-butene, 1-hexene, 4-methyl-1-pentene and 1-octene.

The homopolymer or copolymer of an α-olefin compound represented by CH₂═CH—CₓH₂ₓ₊₁ (wherein x is 0 or a positive integer) used in the invention is not particularly limited, provided that the homopolymer or copolymer is obtained by homopolymerizing or copolymerizing the above α-olefin compound. However, ethylenic polymers such as low density polyethylene, medium density polyethylene, high density polyethylene, linear low density polyethylene, ultrahigh molecular weight polyethylene; propylenic polymers such as propylene homopolymer, propylene random copolymers, propylene block copolymers; polybutene, poly(4-methyl-1-pentene), poly(1-hexene), ethylene-propylene copolymers, ethylene-butene copolymers, ethylene-hexene copolymers, ethylene-octene copolymers, ethylene-(4-methyl-1-pentene) copolymers, propylene-butene copolymers, propylene-(4-methyl-1-pentene) copolymers, propylene-hexene copolymers, propylene-octene copolymers may be preferable.

(A2) Copolymer of an α-Olefin Compound Represented by CH₂═CH—CₓH₂ₓ₊₁ (Wherein x is 0 or a Positive Integer) and a Mono-Olefin Compound Having an Aromatic Ring

For the copolymer of an α-olefin compound represented by CH₂═CH—CₓH₂ₓ₊₁ (wherein x is 0 or a positive integer) and a mono-olefin compound having an aromatic ring (A2) used in the invention, the α-olefin compounds represented by CH₂═CH—CₓH₂ₓ₊₁ (wherein x is 0 or a positive integer) may include the same α-olefin compounds described for the terms of (A1). The mono-olefin compounds having an aromatic ring may include styrenic compounds such as styrene, vinyltoluene, α-methylstyrene, chlorostyrene, styrenesulfonic acid and salts thereof; vinylpyridine.

The copolymer of an α-olefin compound represented by CH₂═CH—CₓH₂ₓ₊₁ (wherein x is 0 or a positive integer) and a mono-olefin compound having an aromatic ring (A2) used in the invention is not particularly limited, provided that the copolymer is obtained by copolymerizing the α-olefin compound and the mono-olefin compound having an aromatic ring above set forth.

(A3) Copolymer of an α-Olefin Compound Represented by CH₂═CH—CₓH₂ₓ₊₁ (Wherein x is 0 or a Positive Integer) and a Cyclic Mono-Olefin Compound Represented by the Following Formula (II)

For the copolymer of an α-olefin compound represented by CH₂═CH—CₓH₂ₓ₊₁ (wherein x is 0 or a positive integer) and a cyclic mono-olefin compound represented by the Formula (I) (A3) used in the invention, the α-olefin compound represented by CH₂═CH—CₓH₂ₓ₊₁ (wherein x is 0 or a positive integer) may include the same α-olefin compounds described for the terms of (A1). The constituent unit derived from the cyclic mono-olefin compound is represented by the following Formula (2).

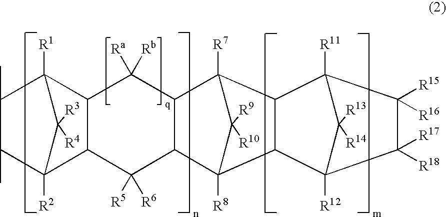

In Formula (2), n, m, q, R¹ to R¹⁸, and R^{a} and R^{b} has the same meanings as in Formula (1).

(II) Ethylene-vinyl Ester Copolymer Resins and (III) ethylene-(meth)acrylate Copolymer Resins

Ethylene-vinyl ester copolymer resins, and ethylene-(meth)acrylate copolymer resins can be produced by a high pressure radical polymerization technique, and are obtained by copolymerizing ethylene and radical polymerizable monomers.

The vinyl esters of the ethylene-vinyl ester copolymer may include vinyl acetate, vinyl propionate, and vinyl neoate.

The (meth)acrylates of the ethylene-(meth)acrylate copolymer may include an unsaturated carboxylic acid ester having 4 to 8 carbon atoms such as acrylates such as methyl acrylate, ethyl acrylate, n-propyl acrylate, isopropyl acrylate, n-butyl acrylate, t-butyl acrylate, and isobutyl acrylate; a methacrylates such as methyl methacrylate, ethyl methacrylate, n-propyl methacrylate, n-butyl methacrylate, t-butyl methacrylate, and isobutyl methacrylate;. These co-monomers can be used singly or in combination of two or more species.

Among the polyolefinic resins comprising one or more selected from the group consisting of (I) to (III) described above, high density polyethylene, medium density polyethylene, ethylenic elastomers, propylenic elastomers, isotactic polypropylene, syndiotactic polypropylene, high pressure low density polyethylene, and copolymers thereof with acrylic acid, acrylates and vinyl acetate, polyolefinic ionomers, 4-methylpentene-1 polymer, ethylene-cyclic olefin copolymers are preferable. Also, those resins resulting from modification of the above-mentioned polyolefin resins by all techniques, such as polyolefin resins graft-modified with acrylate, maleic anhydride or the like in the presence of peroxides are also applied as the polyolefin resin constituting the polyolefin molded product according to the invention.

The polyolefin molded product of the invention is a molded product comprising such polyolefin resins as the main component, and may also contain all other materials, for example, resins other than the above-mentioned polyolefin resins, flame retardant or inorganic filler component, and the like. The polyolefin molded product of the invention may be made from a composition containing various additives, such as softening agent, stabilizing agent, filler, antioxidant, crystal nucleating agent, wax, thickening agent, mechanical stability imparting agent, leveling agent, wetting agent, film-forming aid, crosslinking agent, antiseptic, rust inhibitor, pigment, antifreeze, defoaming agent and the like.

Polar Polymer (B)

The polar polymer (B) constituting the polyolefin-based molded product according to the invention is an addition polymer of a vinyl monomer having heteroatoms or an aromatic ring, or a ring-opened polymer of a small-membered cyclic compound.

The polar polymer (B) comprising these polymers is a homopolymer or copolymer of one or more monomers selected from the organic compounds having at least one carbon-carbon unsaturated bond, and is preferably a polar polymer having a number average molecular weight (Mn) measured by gel permeation chromatography (GPC) in terms of polystyrene, of 100 to 1,000,000, preferably 500 to 500,000, and more preferably 1,000 to 100,000.

Specific examples of these one or more monomers selected from the organic compounds having at least one carbon-carbon unsaturated bond, include (meth)acrylic acid-based monomers such as (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, 2-(dimethylamino)ethyl (meth)acrylate, γ-(methacryloyloxypropyl)trimethoxysilane, ethylene oxide adduct of (meth)acrylic acid, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, and 2-perfluorohexadecylethyl (meth)acrylate; styrenic monomers such as styrene, vinyltoluene, α-methylstyrene, chlorostyrene, styrenesulfonic acid and salts thereof; fluorine-containing vinyl monomers such as perfluoroethylene, perfluoropropylene, and fluorinated vinylidene; silicon-containing vinylic monomers such as vinyltrimethoxysilane, and vinyltriethoxysilane; maleimide-based monomers such as maleic anhydride, maleic acid, monoalkyl esters and dialkyl esters of maleic acid, fumaric acid, monoalkyl esters and dialkyl esters of fumaric acid, maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide; nitrile group-containing vinylic monomers such as acrylonitrile, and methacrylonitrile; amide group-containing vinylic monomers such as (meth)acrylamide, N-methyl(meth)acrylamide, N-ethyl(meth)acrylamide, N-propyl(meth)acrylamide, N-isopropyl(meth)acrylamide, N-butyl(meth)acrylamide, and N,N-dimethyl(meth)acrylamide; vinyl ester-based monomers such as vinyl acetate, vinyl propionate, vinyl pivalate, vinyl benzoate, and vinyl cinnamate; olefinic monomers such as ethylene, propylene, and butene; diene monomers such as butadiene, and isoprene; vinyl chloride, vinylidene chloride, allyl chloride, allyl alcohol ; and also, macromonomers having carbon-carbon unsaturated bond such as acryloyl group, methacryloyl group, styryl group or the like at the terminals, having molecular weights of 100 to 100,000.

The polar polymer (B) formed from an addition polymer, that is used in the invention, is preferably a polymer obtained by (co)polymerizing one or more monomers selected from (meth)acrylic acid and derivatives thereof, (meth)acrylonitrile, and styrene and derivatives thereof, more preferably a homopolymer or copolymer of a (meth)acrylate, styrene (meth)acrylamide, (meth)acrylonitrile, or (meth)acrylic acid, and particularly preferably a homopolymer of methyl methacrylate, styrene, methyl acrylate, acrylonitrile, butyl acrylate or acrylamide, or a copolymer made from these monomer as the main component.

The coat layer comprising the polar polymer (B) is preferably having a flat and smooth surface, when being used for the applications where affinity with other solvents or affinity with other resins is important. In this case, a polar polymer (B) which is insoluble in organic solvents, or a polar polymer (B) which does not form flat and smooth surface is not preferred.

On the other hand, the polar polymer (B) formed from a ring-opened polymer of a small-membered cyclic compound is preferably represented by a structure in which one or more of small-membered cyclic compounds such as lactones, lactams, cyclic ethers, cyclic acid anhydrides or cyclic formals are subjected to ring-opening, and those are added with each other.

The small-membered cyclic compound for obtaining a ring-opened polymer is not particularly limited, provided that the cyclic compound easily undergoes ring-opening polymerization, but is preferably a lactone or a cyclic ether, from the viewpoint of the facility of ring-opening polymerization.

Specific examples of the lactone include glycolides, lactides, and also intermolecular cyclic diesters such as α-hydroxybutyric acid, α-hydroxyvaleric acid, α-hydroxyisovaleric acid, α-hydroxycaproic acid, α-hydroxyisocaproic acid, α-hydroxy-β-methylvaleric acid, α-hydroxyheptanoic acid, and the like. Among these, glycolides and lactides are easily available, and the physical properties of these polymers are favorable, thus being preferred lactones. Also, a lactone having asymmetrical carbons may be any of an L-isomer, a D-isomer, a racemate and a mesomer.

Specific examples of the cyclic ether include ethylene oxide, propylene oxide, isobutylene oxide, cis-1,2-butylene oxide, trans-1,2-butylene oxide, styrene oxide, cyclopentene oxide, cyclohexene oxide, epichlorohydrin, glycidol, glycidylphenyl ether, oxetane, 2-methyloxetane, 2,2-dimethyloxetane, 2-chloromethyloxetane, 3,3-dimethyloxetane, 3methyl-3-chloromethyloxetane, 3,3-bis(chloromethyl)oxetane, 3-(trimethylsilyloxymethyl)oxetane, tetrahydrofuran, 2-methyltetrahydrofuran, 3-methyltetrahydrofuran, 2,5-dimethoxytetrahydrofuran, 2-ethoxytetrahydrofuran, methyltetrahydrofurfuryl ether, 2,3-dihydrobenzofuran, 2,3-dihydrofuran, 2,5-dihydrofuran, tetrahydrofuran acetic acid ethyl ester, tetrahydrofurfuryl chloride, tetrahydrofurfuryl acetate, tetrahydrofurfuryl propionate, tetrahydrofurfuryl n-butyrate, and tetrahydrofurfuryl methacrylate. Among these, ethylene oxide, propylene oxide, oxetane and tetrahydrofuran are preferred from the viewpoint of availability of the raw material.

The polar polymer (B) used in the invention may be a polymer modified with halogen atoms or various molecules at the terminals, and may also be a polymer in which part of the monomer units are hydrolyzed, modified with metals, low molecular weight molecules or introduced reactive groups, or even crosslinked.

Polyolefin-Based Molded Product of the Invention

The polyolefin-based molded product of the invention is the above-described polyolefin-based molded product comprising a polyolefin molded product (A) coated with a polar polymer (B) on the surface, and is characterized in that since the polyolefin-based molded product has a structure in which the polar polymer (B) is bound to the surface of the polyolefin molded product (A) through covalent bonding, delamination of the polar polymer (B), elution caused by various organic solvents, or the like is not likely to occur.

For the mode of this covalent bonding, it is preferable that the polar polymer (B) is directly linked to the polyolefin chains (a) constituting the polyolefin molded product, which are present at the surface of the polyolefin molded product (A), by covalent bonding. However, the polar polymer (B) may also have short spacer-linking part to an extent that the properties of the surface-coating polar polymer (B) are not impaired (preferably, less than 5% by weight of the polar polymer (B)).

However, in this case, the linking part is all essentially formed by a chain of covalent bonds.

Preferably the above covalent bond has chemical stability against external stimulations such as light, heat, and moisture.

From this point of view, when the polar polymer (B) is an addition polymer of a monomer having at least one carbon-carbon unsaturated bond, the linking part between the polar polymer (B) and the surface of the polyolefin molded product (A) is preferably constituted of a covalent bond formed by a carbon-carbon bond or a chain of such bonds. In addition, the term “covalent bond formed by carbon-carbon bond” means that the carbon atom [C_{A}] present at the surface of the polyolefin molded product (A) and the carbon atom [C_{B}] present at the surface of the polar polymer (B) are directly bound, while the term “covalent bond formed by a chain of carbon-carbon bonds” means that the carbon atom [C_{A}] and the carbon atom [C_{B}] are linked through a divalent hydrocarbon group which is constituted of two or more carbon atoms, such as a linear or branched alkylene group, an arylene group or the like. Conventionally, the carbon atom [C_{A}] and the carbon atom [C_{B}] are directly bound.

For example, if the linking part contains an ester bond or a bond involving metal, such bond may easily undergo dissociation under heat, moisture or the like, and cause delamination of the polar polymer (B), under the use conditions of the molded product of the invention or during the course of processing the molded product into all applications such as laminate, coating and the like.

The polyolefin-based molded product of the invention is a product having the surface of a polyolefin molded product (A) coated by a polar polymer (B), but may be partially coated or completely coated in accordance with the uses. Also, the coated portions and the uncoated portions may be two-dimensionally regularly aligned.

Furthermore, at the surface of the polyolefin-based molded product of the invention, the thickness of the polar polymer (B) coating the surface of the polyolefin molded product (A) is to be adjusted in accordance with the desired use, because the thickness is attributable to the kind, molecular weight, or the number of molecules of the polar polymer, but is generally in the range of 1 nm to 5 mm, and preferably 10 nm to 1 mm. The number average molecular weight (Mn) as calculated in terms of polystyrene, of the polar polymer segment (B), which constitutes the coating layer, is preferably 500 to 500,000.

Surface Coated Product and Laminate Formed From Polar Polymer-Coated Polyolefin-Based Molded Product

The polyolefin-based molded product of the invention can exhibit adhesiveness with various materials by selecting the kind of the polar polymer (B) coated on the surface through covalent bonding. Thus, the polyolefin-based molded product in the form of film or sheet can form a laminate with the polyolefin-based molded product which is in the form of the same or different kind of film or sheet, or can form a surface coated product or a laminate with a thermoplastic resin, a metal, glass, a thermosettable resin, or the like.

Method for Producing Polyolefin-Based Molded Product of the Invention

The polyolefin-based molded product of the invention allows coating only the surface of the polyolefin molded product (A) with the polar polymer (B), by polymerizing a polar compound (monomer) using the polymerization initiating group present at the surface of the polyolefin molded product (A) as the point of reaction initiation.

The method for molding processing to produce the polyolefin molded product (A) according to the invention is not particularly limited, and various molding methods that are generally used for thermoplastic resins, namely, injection molding, extrusion molding, blow molding, thermoforming, press molding and the like, can be applied.

The method of introducing a polymerization initiating group to the polyolefin molded product (A) is not particularly limited, but a polyolefin resin having a polymerization initiating group introduced in advance may be subjected to molding, or a polyolefin molded product may be subjected to surface modification with a polymerization initiating group having low molecular weight or high molecular weigh. Alternatively, a polyolefin resin having a polymerization initiating group introduced thereto, which has been molded into film or sheet to coat other resin, metal, paper, and wood, may also be subjected to polymerization with a polar compound (monomer).

For the method for producing the polyolefin-based molded product of the invention, that is, the polyolefin-based molded product coated with the polar polymer (B), the following two production methods (P-1) and (P-2) are preferably used, because of the difference in the process for polymerization of the polar compound (monomer) at the surface of the polyolefin molded product having a polymerization initiating group introduced thereto.

(P-1) Method of Coating a Molded Product Formed From a Polyolefin Having a Radical Polymerization Initiating Group Covalently Bonded Thereto

A method for producing the polyolefin-based molded product by subjecting one or more monomers selected from organic compounds having at least one carbon-carbon unsaturated bond to controlled radical polymerization at the surface of (A′), using the radical polymerization initiating group present at the surface of (A′) as the point of initiation.

(P-2) Method of Coating a Molded Product Formed From a Polyolefin Having a Group Containing Heteroatoms Covalently Bonded Thereto

This is a method for producing the polyolefin-based molded product by subjecting a small-membered cyclic compound to ring-opening polymerization at the surface of (A″), using the heteroatoms present at the surface of (A″) as the point of initiation.

First, the production method of (P-1) according to the invention will be described.

By polymerizing a monomer using controlled radical polymerization at the surface of a molded product (A′) formed from a polyolefin having a radical polymerization initiating group covalently bonded thereto, it is possible to control the primary. structure of the polar polymer (B), such as the molecular weight, molecular weight distribution and molecular terminals.

According to the invention, the type of the controlled radical polymerization to introduce the polar polymer (B) is not particularly limited, but an appropriate technique can be selected in view of facility of the introduction of a polymerization initiating group to the polyolefin, the type of the polar polymer (B), and the polymerization conditions.

For example, a method of generating radicals by binding a group having nitroxide and cleaving the group thermally, as described in Trend Polym. Sci., 4, 456 (1996), or a method called atomic transfer radical polymerization (ATRP), that is, a method of radical polymerizing a radical polymerizable monomer using an organic halide or a halogenated sulfonyl compound as the initiating agent, and a metal complex having a transition metal at the center as the catalyst, as described in Science, 272, 866 (1996); Chem. Rev., 101, 2921 (2001); the international publications of WO 96-30421, WO 97-18247, WO 98-01480, WO 98-40415, and WO 00-156795; or Sawamoto, et al., Chem. Rev., 101, 3689 (2001); JP-A 8-41117, JP-A 9-208616, JP-A-2000-264914, JP-A-2001-316410, JP-A-2002-80523 and JP-A-2004-307872, may be included.

In view of facility of the method for introducing the polymerization initiating terminals for radical polymerization, and abundance of the monomer species that can be selected, the atomic transfer radical polymerization technique is a promising controlled radical polymerization technique for introducing the polar polymer (B) according to the invention.

For the method of introducing an atomic transfer radical polymerization initiating agent to the polyolefin, a functional group transformation method, a direct halogenation method may be effective.

The functional group transformation method refers to a method of converting the functional group moiety of a polyolefin which a functional group such as a hydroxyl group, an acid anhydride group, a vinyl group, and a silyl group is introduced into, to the structure of an atomic transfer radical polymerization initiating agent. Examples include a method of modifying a hydroxyl group-containing polyolefin with a low molecular weight compound such as 2-bromoisobutyric acid bromide, as described in JP-A-2004-131620.

The direct halogenation method refers to a method of obtaining a halogenated polyolefin having carbon-halogen bonds by inducing a halogenating agent to directly act on a polyolefin.

The type of the halogenating agent being used or the halogen atom being introduced is not particularly limited, but in view of the balance between the stability of the atomic transfer radical polymerization initiating skeleton and the initiation efficiency, a brominated polyolefin having bromine atoms introduced thereto is preferred.

A technique of introducing the halogen atom is not particularly limited, but an appropriate technique can be selected in view of facility of introducing the halogen atom to the polyolefin molded product, the type of the polyolefin, and the gentleness of the reaction conditions.

Examples of bromination include a photo-bromination which is the method of brominating alkenes by reacting bromine and alkene compounds with photoirradiation as described in G. A. Russel et al., J. Am. Chem. Soc., 77, 4025 (1955), the method of brominating cyclic alkyl by heating the mixture containing a cyclic alkyl compound, carbon tetrabromide and 50% NaOH to reflux as described in P. R. Schneiner et al., Angew. Chem. Int. Ed. Engl., 37, 1895 (1998), and the method of brominating a terminal alkyl group by radical reaction of N-bromosuccinimide with a radical initiator such as azobisisobutyronitrile.

Above methods are suitable to the polyolefin resin or the molded product thereof such as polyolefins made from ethylene mainly including high density polyethylene, intermediate density polyethylene, ethylene elastomer and high pressure low density polyethylene, and ethylene copolymers such as ethylene-acrylic acid copolymer, ethylene-acrylate copolymer, and ethylene-vinyl acetate copolymer.

In the case of polyolefins made from α-olefin mainly, and cyclic olefin polymers, such as isotactic polypropylene, syndiotactic polypropylene, propylene elastomer, and ethylene-cyclic olefin copolymer, backbone chains thereof are generally prone to be cleaved in the presence of free radicals. Therefore, free radicals generated from the halogenating agent must be suppressed. If ATRP is carried out on the polyolefin molded product surface having low molecular weight polyolefins derived from backbone chain scission, products containing the polar polymer (B) may be stripped from the polyolefin molded product surface during or after polymerization and a polyolefin-based molded product with a coating layer of a polar polymer(B) without stripping may be difficult to be obtained. Particularly, in the case of using bromine as the brominating agent, bromination may preferably be carried out in the absence of light as far as possible in order to suppress the high concentration of bromo radical.

Furthermore, as disclosed in Science, 272, 866 (1996), the preferable initiating structure for the atomic transfer radical polymerization is a structure having a low dissociating energy for the carbon-halogen atom bond. Therefore, a halogenating agent that can easily form a structure in which a halogen atom is directly introduced to a tertiary carbon atom or a structure in which a halogen atom is introduced to a carbon atom bound to an unsaturated carbon-carbon bond of a vinyl group, a vinylidene group or the like may be used preferably.

From this point of view, in the case of producing a halogenated polyolefin according to the direct halogenation method, preferred halogenating agents include bromine and N-bromosuccinamide (NBS).

In performing the controlled radical polymerization according to the invention, a solvent may be used or not be used. The solvent that can be used may be any solvent, provided that it does not suppress the polymerization reaction, and it does not dissolve the molded product formed from a polyolefin having a radical polymerization initiating agent introduced thereto (A′). Examples of the solvent include aromatic hydrocarbon-based solvents such as benzene, toluene, and xylene; aliphatic hydrocarbon-based solvents such as pentane, hexane, heptane, octane, nonane, and decane; alicyclic hydrocarbon-based solvents such as cyclohexane, methylcyclohexane, and decahydronaphthalene; chlorinated hydrocarbon solvents such as chlorobenzene, dichlorobenzene, trichlorobenzene, methylene chloride, chloroform, carbon tetrachloride, and tetrachloroethylene ; alcohol solvents such as methanol, ethanol, n-propanol, isopropanol, n-butanol, sec-butanol, and tert-butanol; ketone solvents such as acetone, methyl ethyl ketone, and methyl isobutyl ketone ; ester solvents such as ethyl acetate, and dimethyl phthalate; ether solvents such as dimethyl ether, diethyl ether, di-n-amyl ether, tetrahydrofuran and dioxyanisole. Water also can be used as the solvent. These solvents may be used singly or in combination of two or more species.

The polymerization temperature can be set to any temperature at which the molded product formed from a polyolefin having a radical polymerization initiating group introduced thereto (A′) does not melt or swell, and the radical polymerization reaction proceeds. The polymerization temperature may vary depending on the degree of polymerization of the desired polymer, the radical polymerization initiating agent being used, and the type or amount of the solvent, but the temperature is usually −50° C. to 150° C., preferably 0° C. to 80° C., and more preferably 0° C. to 50° C. The polymerization reaction can be performed under any of the conditions of reduced pressure, normal pressure and overpressure, depending on the circumstances. The polymerization reaction is preferably performed after removing oxygen, in an atmosphere of inert gas such as nitrogen, argon or the like so as to suppress any side reactions.

Next, (P-2) will be described.

In the molded product formed from a polyolefin having a group containing heteroatoms covalently bonded thereto (A″) according to the invention, the group containing heteroatoms is a group having an ability to initiate ring-opening polymerization of a small-membered cyclic compound, that is, a group which is able to generate an active species for ring-opening polymerization by generating anions or cations under a specific temperature condition, or upon addition of an acid or base catalyst.

Specifically, good examples include a hydroxyl group, a carboxyl group, an acid anhydride group, an epoxy group, an amino group, and a reaction product thereof with a metal compound.

For example, in the case of performing ring-opening polymerization of lactide classified into lactones, a polyolefin-based molded product coated with polylactic acid on the surface can be obtained by using a polyolefin molded product having a hydroxyl group covalently bonded to the surface in the presence of the corresponding monomer, and adding a metallic catalyst such as tin octanoate or the like.

In performing the ring-opening polymerization of the invention, a solvent may be used or may not be used. The solvent that can be used may be any solvent provided that it does not suppress the polymerization reaction and it dose not dissolve the polyolefin molded product, but aprotic solvents are preferred. Specific examples of such solvent include aromatic hydrocarbon solvents such as benzene, toluene, and xylene; aliphatic hydrocarbon solvents such as pentane, hexane, heptane, octane, nonane, and decane; alicyclic hydrocarbon solvents such as cyclohexane, methylcyclohexane and decahydronaphthalene; chlorinated hydrocarbon solvents such as chlorobenzene, dichlorobenzene, trichlorobenzene, methylene chloride, chloroform, carbon tetrachloride, and tetrachloroethylene; ketone solvents such as acetone, methyl ethyl ketone, and methyl isobutyl ketone; ester solvents such as ethyl acetate, and dimethyl phthalate; ether solvents such as dimethyl ether, diethyl ether, di-n-amyl ether, tetrahydrofuran and dioxyanisole. These solvents may be used singly or in combination of two or more species.

The reaction temperature may be any temperature at which the molded product formed from a polyolefin having a group containing heteroatoms covalently bonded thereto (A″) does not melt or swell, and the ring-opening polymerization reaction proceeds. The polymerization temperature may vary depending on the degree of polymerization of the desired polymer, the radical polymerization initiating agent being used, and the type or amount of the solvent, but the temperature is usually −50° C. to 150° C., preferably 0° C. to 80° C., and more preferably 0° C. to 50° C. The polymerization reaction can be performed under any of the conditions of reduced pressure, normal pressure and overpressure, depending on the circumstances.

In addition, in the case of performing the ring-opening polymerization, the small-membered cyclic compound, solvent and catalyst component being used are preferably used as purified, and in particular, in order not to generate ring-opened homopolymers as side products, it is preferable to perform the polymerization in a system where moisture has been sufficiently removed.

Uses of Polyolefin-Based Molded Product

The polyolefin-based molded product according to the invention can be used in various applications, and for example, can be used for the following applications.

(1) Film and sheet, or laminate thereof: The film and sheet formed from the polyolefin-based hybrid polymer according to the invention are excellent in any of flexibility, transparency, tackiness, hydrophilicity, antifogging property, heat resistance, gas barrier property, adhesiveness, dissolubility, impact resistance, hydrophobicity, biocompatibility, strength, wear resistance and conductivity.

(2) Laminate comprising at least one layer formed from the polyolefin-based molded product according to the invention: For example, agricultural film, wrapping film, shrinking film, protective film, separating membranes such as plasma component separating membrane, water-selective pervaporation membrane and the like, selective separative membranes such as ion exchange membrane, battery separator, optical resolution membrane and the like.

(3) Microcapsules, PTP packaging, chemical valve, drug delivery systems.

(4) Materials for construction and civil engineering: Resins for construction and civil engineering and molded products for construction and civil engineering such as, for example, floor material, floor tile, floor sheet, sound insulating sheet, insulating panel, vibration isolating material, decorative sheet, baseboard, asphalt modifier, gasket, ceiling material, roofing sheet, water sealing sheet and the like.

(5) Interior materials and covering materials for automobile, and gasoline tank: The interior materials and covering materials formed from the polybranched type polymer according to the invention are excellent in toughness, impact resistance, oil resistance and heat resistance.

(6) Electronic insulating material for electrical and electronic parts and the like; material for electronic parts treatment; magnetic recording medium, binder for magnetic recording medium, conductive film, sealing material for electric circuit, material for household electric appliances, container material for containers such as container for microwave oven and the like, film for microwave oven, polymer electrolyte base material, conductive alloy base material and the like. Electrical and electronic parts represented by connector, socket, resistor, relay case switch coil bobbin, condenser, variable condenser case, optical pickup, optical connector, oscillator, various terminal blocks, transformer, plug, printed wiring board, tuner, speaker, microphone, headphone, small motor, magnetic head base, power module, housing, semiconductor, liquid crystal display parts, FDD carriage, FDD chassis, HDD parts, motor brush holder, parabola antenna, computer parts; VTR parts, television parts, iron, hair dryer, rice cooker parts, microwave oven parts, audio instrument parts such as audio parts, Audio-Laser Disk (trademark), compact disk and the like, parts for domestic, office electrical goods represented by lighting parts, refrigerator parts, air conditioner parts, typewriter parts, word processor parts and the like, office computer parts, telephone parts, facsimile parts, copying machine parts, electromagnetic shielding material, speaker cone material, oscillating device for speaker and the like.

(7) Surface cured material: Since the molded articles comprising the polyolefin-based molded product according to the invention have excellent affinity to acrylic monomers or polyfunctional monomers, that can be used as photo-cured materials or thermally cured materials having coating layer made from acrylic monomers, polyfunctional monomers, or coating compositions on the surface of the molded articles.

(8) Medical goods such as non-woven fabric for medical and hygienic material, non-woven fabric laminate, electret, medical tube, medical container, infusion solution bag, prefilled syringe, injection syringe and the like, medical material, cell culture platform, artificial organs, artificial muscle, filtering membrane, food hygiene and health products; retort bag, freshness keeping film and the like.

(9) Miscellaneous goods: Stationeries such as desk mat, cutting mat, ruler, pen body, grip cap, grip for scissors, cutter or the like, magnet sheet, pen case, paper folder, binder, label seal, tape, whiteboard and the like; daily goods for living such as clothes, curtain, sheet, carpet, door mat, bath mat, bucket, hose, bag, planter, filter for air conditioner or exhaust fan, tableware, tray, cup, lunchbox, funnel for coffee siphon, eyeglass frame, container, storage case, hanger, rope, laundry net, and the like; sports goods such as shoes, goggles, ski board, racket, ball, tent, water goggles, flippers, fishing rod, cool box, leisure seat, sports net and the like; toys such as blocks, cards and the like; vessels such as kerosene can, drum, bottle for detergent or shampoo, and the like; displays such as advertising display, pylon, plastic chains and the like; and the like.

Hereinafter, the present invention will be described in more detail with reference to Examples, but the invention is not intended to be limited by these Examples. The X-ray photoelectron spectroscopic analysis of the molded product surface presented in the Examples was performed using an SSX-100 X-ray photoelectron spectrometer manufactured by SSI, Inc., while the distribution state of bromine atom was analyzed by employing an EPMA-1600 electron beam microanalyzer manufactured by Shimadzu Corp. Further, the ATR/IR analysis was performed using an FTS-6000 infrared spectrophotometer manufactured by Bio-Rad Laboratories, Inc.

### EXAMPLES

### Production Example 1

[Preparation of Polypropylene Molded Product Having Radical Polymerization Initiating Group at the Surface (1)]

170 g of a propylene/10-undecen-1-ol copolymer produced according to the method described in JP-A-2002-145944 (molecular weight measured by high temperature GPC and calculated in terms of polypropylene Mw=26400, Mw/Mn=1.71, co-monomer content obtained from ¹H-NMR measurement: 1.0 mol %) was placed in a 2-L glass polymerization vessel which had been deaerated and purged with nitrogen, and 1700 mL of hexane and 9.2 mL of 2-bromoisobutyric acid bromide were respectively added thereto. The polymerization vessel was heated to 60° C., and was heated and stirred for 2 hours. The slurry-like polymer solution which had been returned to room temperature was filtered with a Kiriyama funnel, and then, the polymer on the funnel was rinsed three times with 200 mL of methanol. The polymer was dried at 50° C. under a reduced pressure of 10 Torr for 10 hours, to obtain a white polymer. The result of 1H-NMR showed that the polymer was a halogen atom-containing polypropylene having 94% of the terminal OH groups modified with 2-bromoisobutyric acid group. This halogen atom-containing polypropylene was molded with a compression molding machine (180° C., 10 MPa) into a sheet having a thickness of 1.0 mm.

As a result of performing a surface analysis of the polypropylene molded product by ATR/IR measurement, the absorption of the ester carbonyl stretching vibration at 1730 cm⁻¹ could be confirmed, and it was clear through XPS measurement that 0.3 atm % of bromine atoms were present at the surface. From these results, it was confirmed that atomic transfer radical polymerization initiating terminals were present at the surface of the polypropylene molded product.

### Production Example 2

[Preparation of Polypropylene Molded Product Having Radical Polymerization Initiating Group at the Surface (2)]

A polypropylene manufactured by Mitsui Chemicals, Inc. ([η]=2.6) was molded into a sheet having a size of 4 cm×4 cm and a thickness of 1.0 mm, using a compression molding machine (180° C., 10 MPa). The molded product was immersed in 50 mL of butyl acetate solvent, the inside of the reactor was purged with nitrogen through nitrogen bubbling, and then 0.5 mL of dry bromine was added thereto on the condition of light shielding . The system was heated to 50° C. and slowly stirred with a stirrer tip. After allowing the reaction to proceed for 24 hours, the polypropylene sheet was cooled to room temperature and pulled up, and the surface was washed with acetone. As a result of performing a surface analysis of the polypropylene molded product by XPS measurement, it was clear that 0.5 atm % of bromine atoms were present at the surface.

### Production Example 3

[Preparation of Polyethylene Molded Product Having Ring-Opening Polymerization Initiating Group at the Surface (1)]

An ethylene/10-undecen-1-ol copolymer produced according to JP-A-2002-145944 (molecular weight measured by GPC and calculated in terms of polystyrene Mw=90400, Mw/Mn=2.53, co-monomer content obtained from ¹H-NMR measurement: 3.9 mol %) was molded into a sheet having a size of 4 cm×4 cm and a thickness of 1.0 mm, using a compression molding machine (150° C., 10 MPa).

As a result of performing a surface analysis of the polyethylene molded product by ATR/IR measurement, a broad absorption was observed in the vicinity of 3500 cm⁻¹, and thus, it was confirmed that hydroxyl groups were present at the surface of the molded product.

### Example 1

[Polypropylene-Based Molded Product Coated With Poly((2-hydroxylmethyl) Methacrylate (=PHEMA))

The polypropylene molded product having radical polymerization initiating group at the surface, obtained in Production Example 1, was placed in a glass reactor, and was immersed in a sufficiently nitrogen bubbled liquid mixture of 250 mL of ethanol and 40 mL of (2-hydroxyethyl) methacrylate, with the reactor being further purged with nitrogen. To this, a homogeneous solution of cuprous bromide (548 mg), 3.75 mL of a 2 M xylene solution of N,N,N′,N″,N″-pentamethyldiethylenetriamine, and 5.0 mL of xylene was added and slowly stirred at 25° C. for 24 hours. The immersed polypropylene molded product was taken out, the surface was washed several times with acetone, and the molded product was dried at 50° C. and at a reduced pressure of 10 Torr for 10 hours. The surface of the obtained polypropylene molded product was analyzed by ATR/IR, and a broad absorber attributable to OH stretching vibration was observed at 3200 cm⁻¹ to 3600 cm⁻¹, and an absorber attributable to ester carbonyl stretching vibration was observed in the vicinity of 1730 cm⁻¹. From these results, it was confirmed that poly((2-hydroxyethyl) methacrylate) was present at the surface of the polypropylene molded product. Further, from the transmission electron microscopic (TEM) photographs of the cross-section of the molded product, it was confirmed that poly((2-hydroxyethyl) methacrylate) was completely coating the surface of the polypropylene sheet to a thickness of about 10 μm to 20 μm. When this polypropylene molded product was treated with THF, no weight change was observed. This implied that poly((2-hydroxyethyl) methacrylate) was coating through covalent bonding to the polypropylene main chain present at the polypropylene base surface. From the results of the measurement of water contact angle of the surface (Table 1), it was obvious that hydrophilicity of the surface of the polypropylene molded product was significantly enhanced.

### Example 2

[Polypropylene-Based Molded Product Coated With Polymethyl Methacrylate (=PMMA)]

The polypropylene molded product having radical polymerization initiating groups on the surface, which was obtained in Production Example 1, was placed in a glass reactor, and was immersed in a sufficiently nitrogen bubbled liquid mixture of 150 mL of THF and 150 mL of methyl methacrylate, with the reactor being further purged with nitrogen. To this, a homogeneous solution of cuprous bromide (548 mg), 3.75 mL of a 2 M xylene solution of N,N,N′,N″,N″-pentamethyldiethylenetriamine, and 5.0 mL of xylene was added and slowly stirred at 60° C. for 10 hours. The polymerization solution was returned to room temperature, the immersed polypropylene molded product was taken out, and the surface was washed several times with acetone. The molded product was dried at 50° C. and at a reduced pressure of 10 Torr for 10 hours. The surface of the obtained polypropylene molded product was analyzed by ATR/IR, and peaks characteristic to PMTMA were observed at 1730 cm⁻¹, 1270 cm⁻¹, 1242 cm⁻¹, 1193 cm⁻¹ and 1149 cm⁻¹, thus the presence of PMMA on the sheet surface being confirmed.

Furthermore, from the transmission electron microscopic (TEM) photographs of the cross-section of the molded product, it was confirmed that PMMA was completely coating the surface of the polypropylene sheet to a thickness of about 40 μm to 60 μm. From the results of the measurement of water contact angle of the surface (Table 1), it was obvious that hydrophilicity of the surface of the polypropylene molded product was significantly enhanced.

### Example 3

[Polypropylene-Based Molded Product Coated With Polymethyl Methacrylate (=PMMA)]

The polypropylene molded product having radical polymerization initiating groups on the surface, which was obtained in Production Example 2, was placed in a glass reactor, and was immersed in a sufficiently nitrogen bubbled liquid mixture of 150 mL of THF and 150 mL of methyl methacrylate, with the reactor being further purged with nitrogen. To this, a homogeneous solution of cuprous bromide (548 mg), 3.75 mL of a 2 M xylene solution of N,N,N′,N″,N″-pentamethyldiethylenetriamine, and 5.0 mL of xylene was added and slowly stirred at 60° C. for 10 hours. The polymerization solution was returned to room temperature, the immersed polypropylene molded product was taken out, and the surface was washed several times with acetone. The molded product was dried at 50° C. and at a reduced pressure of 10 Torr for 10 hours. The surface of the obtained polypropylene molded product was analyzed by ATR/IR, and peaks characteristic to PMMA were observed at 1730 cm⁻¹, 1270 cm⁻¹, 1242 cm⁻¹, 1193 cm⁻¹ and 1149 cm⁻¹, thus the presence of PMMA on the sheet surface being confirmed. From the results of the measurement of water contact angle of the surface (Table 1), it was obvious that hydrophilicity of the surface of the polypropylene molded product was significantly enhanced.

TABLE 1
Water contact angle of polypropylene-based molded
product coated with acrylate monomer on the surface

| Molded | Polyolefin molded | Polar polymer | Water contact |
|---|---|---|---|
| product | product (A) | (B) | angle (°) |
| Example 1 | PP hot pressed sheet | PHEMA | 25 |
| Example 2 | PP hot pressed sheet | PMMA | 80 |
| Example 3 | PP hot pressed sheet | PMMA | 76 |
| Comp. Ex. 1 | PP hot pressed sheet | None | 101 |

### Comparative Example 1

A polypropylene manufactured by Mitsui Chemicals Inc. ([η]=2.6) was molded into a sheet having a size of 4 cm×4 cm and a thickness of 1.0 mm, using a compression molding machine (180° C., 10 MPa). On that polypropylene sheet molded product (hereinafter, PP sheet), a PMMA resin dissolved in toluene (manufactured by Sigma-Aldrich Company, weight average molecular weight: about 15000) was coated, and dried overnight at room temperature under reduced pressure. It was confirmed by ATR/IR measurement that PMMA was coated on the surface.

Evaluation of Chemical Stability of Coated Polar Polymer

Next, the polypropylene-based molded products produced in the Examples and Comparative Examples were subjected to an evaluation of the chemical stability (organic solvents and alkali water) of the coated polar polymer layer.

[Chemical Stability Evaluation Method 1 (THF Treatment)]

The polypropylene molded product sheets coated with PMMA on the surface (hereinafter, PP sheet), which were obtained in Examples 1 to 3 and Comparative Example 1, were placed in glass vessels, and were immersed in tetrahydrofuran (THF) such that the PP sheets were sufficiently submerged. The systems were slowly stirred overnight with stirrers at 50° C., then the PP sheets were taken out with forceps, and the surfaces were washed with THF several times. The obtained PP sheets were dried at 50° C. and at a reduced pressure of 10 Torr for 10 hours. The results of ATR/IR analysis of the obtained sheet surfaces are presented in Table 2.

[Chemical Stability Evaluation Method 2 (Alkali Treatment)]

The polypropylene molded product sheets coated with PMMA on the surface (hereinafter, PP sheet), which were obtained in Examples 2 and 3, were placed in glass vessels, and were immersed in a liquid mixture (volume ratio 9:1) of tetrahydrofuran (THF) and a 1 M aqueous solution of sodium hydroxide, such that the PP sheets were sufficiently submerged. The systems were slowly stirred overnight with stirrers at 45° C., then the PP sheets were taken out with forceps, and the surfaces were washed with THF several times. The obtained PP sheets were dried at 50° C. and at a reduced pressure of 10 Torr for 10 hours. The results of ATR/IR analysis of the obtained sheet surfaces are presented in Table 2.

TABLE 2
Evaluation results of chemical stability of coated
polar polymer

| | | | ATR/IR | ATR/IR |
|---|---|---|---|---|
| | Polar | (A) − (B) | measurement | measurement |
| | polymer | linking | results after THF | results after |
| | (B) | part | treatment | alkali treatment |
| Ex. 1 | PHEMA | Contains | No change from | PHEMA reduced |
| | | ester bond | before treatment | |
| Ex. 2 | PMMA | Contains | No change from | Loss of PMMA |
| | | ester bond | before treatment | |
| Ex. 3 | PMMA | Only C—C | No change from | No change from |
| | | bond | before treatment | before treatment |
| Comp. | PMMA | No covalent | Loss of PMMA | Loss of PMMA |
| Ex. 1 | | bond | | peaks |

From Table 2, it is obvious that for the polypropylene-based molded products obtained in Examples 1 to 3, there was no change in the absorption band of the polar segment in the ATR/IR measurement due to the treatment with THF, and delamination of the polar polymer due to the THF treatment did not occur substantially. On the other hand, for the polypropylene-based molded products after alkali treatment, while the molded products of Examples 1 and 2 and Comparative Example 1 were observed to have reduction or loss of the absorption band assigned to the polar segment at the surface, the molded product of Example 3 was not observed to have any changes in the PMMA absorption band due to the alkali treatment. It is contemplated that in Examples 1 and 2, the ester bond at the linking part was hydrolyzed by the treatment under alkaline conditions, and part or the entirety of the polar polymer was delaminated. From the above results, it was clear that the linkage between the polyolefin molded product (A) and the polar polymer (B) through covalent bonding, induced by the presence of covalent bonds according to the invention, was contributing in the preservation of chemical stability, which is one of the feature of the molded product of the invention. Furthermore, it was shown that the molded product having a binding group which does not contain hydrolysable ester bonds but comprises carbon-carbon bonds, had particularly excellent chemical stability.

### Example 4

[Polyethylene-Based Molded Product Coated With Polylactic Acid]

50 mL of dehydrated toluene was poured into a 200-mL flat-bottomed separable flask equipped with a magnetic stirrer, and one sheet of the polyethylene sheet molded product obtained in Production Example 3 was placed in the flask, with the flask being sufficiently purged with nitrogen. To this flask, 1 mL of a toluene solution of triethylaluminum (1 M) was gently poured using a syringe. In a nitrogen atmosphere, the polyethylene molded product and triethylaluminum were brought to sufficient contact in the system, by slowly stirring the system at 40° C. After 30 minutes, while maintaining the nitrogen atmosphere, toluene and excessive triethylaluminum in the flask were removed by decantation, and the polyethylene molded product was washed two times with 100 mL of dehydrated toluene.

After sufficiently removing the solvent in the flask, 50 mL of dehydrated acetone was poured, and 4.0 g of DL-lactide was added thereto, and a reaction was allowed to proceed in a nitrogen atmosphere at 40° C. for 24 hours. After completion of the reaction, the polyethylene molded product in the flask was taken out, and washed with 300 mL of methanol. The obtained polyethylene molded product was dried at 40° C. and at a reduced pressure of 10 Torr for 10 hours, and a surface analysis by ATR/IR measurement was performed. An absorption attributable to the ester carbonyl stretching vibration was observed at 1760 cm⁻¹, and thus, the presence of polylactic acid at the surface of the molded product was observed.

### Example 5

[Polyethylene-based molded product coated with poly(ε-caprolactone)]

50 mL of dehydrated toluene was poured into a 200-mL flat-bottomed separable flask equipped with a magnetic stirrer, and one sheet of the polyethylene sheet molded product obtained in Production Example 3 was placed in the flask, with the flask being sufficiently purged with nitrogen. To this flask, 1 mL of a toluene solution of triethylaluminum (1 M) was gently poured using a syringe. In a nitrogen atmosphere, the polyethylene molded product and triethylaluminum were brought to sufficient contact in the system, by slowly stirring the system at 40° C. After 30 minutes, while maintaining the nitrogen atmosphere, toluene and excessive triethylaluminum in the flask were removed by decantation, and the polyethylene molded product was washed two times with 100 mL of dehydrated toluene.

After sufficiently removing the solvent in the flask, 60 mL of dehydrated acetone was poured, and 5.5 g of ε-caprolactone was added thereto, and a reaction was allowed to proceed in a nitrogen atmosphere at 40° C. for 24 hours. After completion of the reaction, the polyethylene molded product in the flask was taken out, and washed with 300 mL of methanol. The obtained polyethylene molded product was dried at 40° C. and at a reduced pressure of 10 Torr for 10 hours, and a surface analysis by ATR/IR measurement was performed. An absorption attributable to the ester carbonyl stretching vibration was observed at 1740 cm⁻¹, and thus, the presence of poly (ε-caprolactone) at the surface of the molded product was observed.

1. A polyolefin-based molded product comprising a polyolefin molded product (A) coated with a polar polymer (B) on a surface thereof, which molded product has a structure in which the polar polymer (B) is chemically bound to the surface of the polyolefin molded product (A) through covalent bonding.

2. The polyolefin-based molded product according to claim 1, wherein the polar polymer (B) is an addition polymer of a monomer having at least one carbon-carbon unsaturated bond.

3. The polyolefin-based molded product according to claim 1, wherein the polar polymer (B) is an addition polymer of a monomer having at least one carbon-carbon unsaturated bond, and the linking part between the polar polymer (B) and the surface of the polyolefin molded product (A) consists of a covalent bond of a carbon-carbon bond or a chain of carbon-carbon bonds.

4. The polyolefin-based molded product according to claim 1, wherein the polar polymer (B) is a ring-opened polymer.

5. A method for producing the polyolefin-based molded product according to claim 1 comprising the step of subjecting one or more monomers selected from organic compounds having at least one carbon-carbon unsaturated bond to controlled radical polymerization from a radical polymerization initiator which is covalently bonded to a polyolefin molded product (A′) and present at the surface of the polyolefin molded product (A′).

6. A method for producing the polyolefin-based molded product according to claim 1, comprising the step of subjecting a small-membered cyclic compound to ring-opening polymerization from a heteroatom which is covalently bonded to a polyolefin molded product (A″) and present at the surface of the polyolefin molded product (A″).

7. The polyolefin-based molded product according to claim 1, which is in the form of film or sheet.

8. A resin molded product coated with the polyolefin-based molded product according to claim 1.

9. A laminate comprising one or more layers of the polyolefin-based molded product according to claim 1.

10. A laminate comprising a layer of the polyolefin-based molded product according to of claim 1 and a layer of a thermoplastic resin film.

11. A laminate comprising a layer of the polyolefin-based molded product according to claim 1 and a layer of a metal film.

12. A laminate comprising a layer of the polyolefin-based molded product according to claim 1 and a layer of a polyester film.

13. A laminate comprising a layer of the polyolefin-based molded product according to claim 1 and a glass layer.
